(19) United States
(12) Patent Application Publication
(10) Pub. No.: US 2003/0031502 A1
(43) Pub. Date: Feb. 13, 2003

(54) Binding element stacking structure

(76) Inventor: Wayne H. Rothschild, Northbrook, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/220,343

(22) PCT Filed: Feb. 28, 2001
(86) PCT No.: PCT/US01/06362

(51) Int. Cl. B42F 3/00

(52) U.S. Cl. 402/60

(57) ABSTRACT

For binding a stack of perforated sheets, an elongated binding element having separable stacking pins disposed on the binding elements to separate and fix the positions of the binding elements. The stacking pins are preferably in the form of nesting pins disposed at opposite ends of an elongated spine of the binding element to maintain the binding element in a stable position relative to surrounding binding elements. Nested or stacked binding elements may be so utilized in automatic binding processes such that the stacking pins may be severed from the binding element either before, during, or after the binding process itself.

### FIELD OF THE INVENTION

The present invention relates to binding elements for holding a plurality of perforated sheets or the like, and more specifically the invention pertains to structure for facilitating stacking or otherwise nesting of binding elements.

### BACKGROUND OF THE INVENTION

Various types of binding elements have been utilized to bind a stack of perforated sheets or the like. Examples of such binding elements which are of a wire comb or hanger-type design are disclosed, for example, in U.S. Pat. No. 2,112,389 to Trussell and U.S. Pat. Nos. 4,832,370 and 4,873,858 to Jones, while machines for assembling such binders are disclosed in U.S. Pat. No. 4,031,585 to Adams, U.S. Pat. No. 4,398,856 to Archer et al., U.S. Pat. No. 4,525,117 to Jones, U.S. Pat. No. 4,934,890 to Flatt, and U.S. Pat. No. 5,370,489 to Bagroky. Other binding devices are disclosed, for example, in the following references: U.S. Pat. Nos. 2,089,881 and 2,363,848 to Emmer, U.S. Pat. No. 2,435,848 to Schade, U.S. Pat. No. 2,466,451 to Liebman, U.S. Pat. No. 4,607,970 to Heusenkveld, U.S. Pat. No. 4,904,103 to Im, U.S. Pat. No. 5,028,159 to Amrich et al., U.S. Pat. No. 4,369,013, Reexamination Certificate U.S. Pat. Nos. B1 4,369,013 and Re. 28,202 to Abildgaard et al. Machines for assembling plastic comb or finger binding elements are disclosed in patents such as U.S. Pat. Nos. 4,645,399 to Scharer, U.S. Pat. No. 4,900,211 to Vercillo, U.S. Pat. No. 5,090,859 to Nanos et al., and U.S. Pat. No. 5,464,312 to Hotkowski et al. The patents are included herein by reference.

Binding elements typically include a spine from which a plurality of fingers extend which may be assembled through perforations in a stack of sheets. This spine may be linear, with or without a longitudinally extending hinge. Alternately, the spine may be formed by sequential bending of a wire, as with wire comb or hanger type binding elements.

Due to the structure of such binding devices, which include elongated spines and fingers, the binding devices commonly become entangled when stored in a group. Detangling the binding elements in order to assemble the element to a stack of sheets or lay the element into a binding machine can be a tedious and potentially time consuming process. Further, this tendency to become entangled may complicate or prevent the use of such binding devices in automated binding processes or machines wherein an automated feed is desirable.

### OBJECTS OF THE INVENTION

It is a primary object of the invention to provide a binding device with reduced susceptibility to tangling, and a more specific object is to provide a binding device which may be stacked to prevent tangling and to facilitate automated feeding of the device in a binding machine.

Another object of the invention is to provide a stacking structure which does not interfere with the use or final appearance of a binding element. A related object is to provide stacking structure which may be severed from the binding element during an automated binding process.

An additional object of the invention is to provide stacking structure which may be economically and efficiently manufactured.

A further object is to provide stacking structure which may be unitarily molded with the binding element using conventional molding techniques.

These and other objects and advantages of the invention will be apparent to those skilled in the art upon reading the following summary and detailed description and upon reference to the drawings.

### SUMMARY OF THE INVENTION

In accordance with the invention, there is provided an elongated binding element having severable stacking pins or alignment pins disposed at opposite ends thereof. Where the binding element includes a spine with protruding fingers, the alignment pins are preferably unitarily formed at opposite ends of the spine. The alignment pins may be alternately disposed on the binding element, or more than two pins may be provided per binding element. The alignment pins are positioned and preferably include a nesting structure such that adjacently disposed binding element may be maintained in a stable position, e.g., in a horizontal position. For example, the binding pins may have a cone shape or include mating protrusions and indentations. While the pins and binding elements are preferably formed of a polymeric material, stacking pins may likewise be utilized with binders formed of metallic materials.

Before, during or after the binding process, the stackable pins are preferably severed from the binding element. With automated processes, such as are well known in the art, severing of the pins may be accomplished by means of a separate procedure or coincident with another movement of the binding machine during the binding process. By way of example only, the pins may be severed as a machine element moves to exert force on the stack of sheets.

The binding element with stackable pins may be economically and efficiently manufactured as pins may be unitarily formed with the binding element as part of a single molding process as is known in the art.

These and other objects and advantages of the invention will be apparent to those skilled in the art upon reading the following summary and detailed description and upon reference to the drawings.

### DESCRIPTION OF THE DRAWINGS

FIG. 1 is a perspective view of a binding element with stackable pins according to teachings of the present invention.

FIG. 2 is a plan view of a binding element of FIG. 1.

FIG. 3 is an end view of the binding element of FIG. 1 wherein the stackable pin is shown in cross-section as taken along line 3-3 in FIG. 1.

FIG. 4 is a cross-sectional view of two stacked binding elements taken along line 4-4 in FIG. 2.

FIG. 5 is an plan view of an alternate embodiment of the invention.

FIG. 6 is an end view of the binding element of FIG. 5 wherein the stackable pin is shown in cross-section as taken along line 6-6 in FIG. 5.

FIG. 7 is a cross-sectional view of two stacked binding elements taken along line 7-7 in FIG. 5.

FIG. 8 is a plan view of a third embodiment of the invention.

FIG. 9 is a side view of a fourth embodiment of the binding element constructed in accordance with teachings of the invention.

FIG. 10 is an end cross-sectional view taken along line 10-10 in FIG. 9.

FIG. 11 is a plan view of two binding elements of FIG. 9 wherein the stackable pins are shown in cross-section taken along line 11-11 in FIG. 9.

### DESCRIPTION OF THE PREFERRED EMBODIMENT

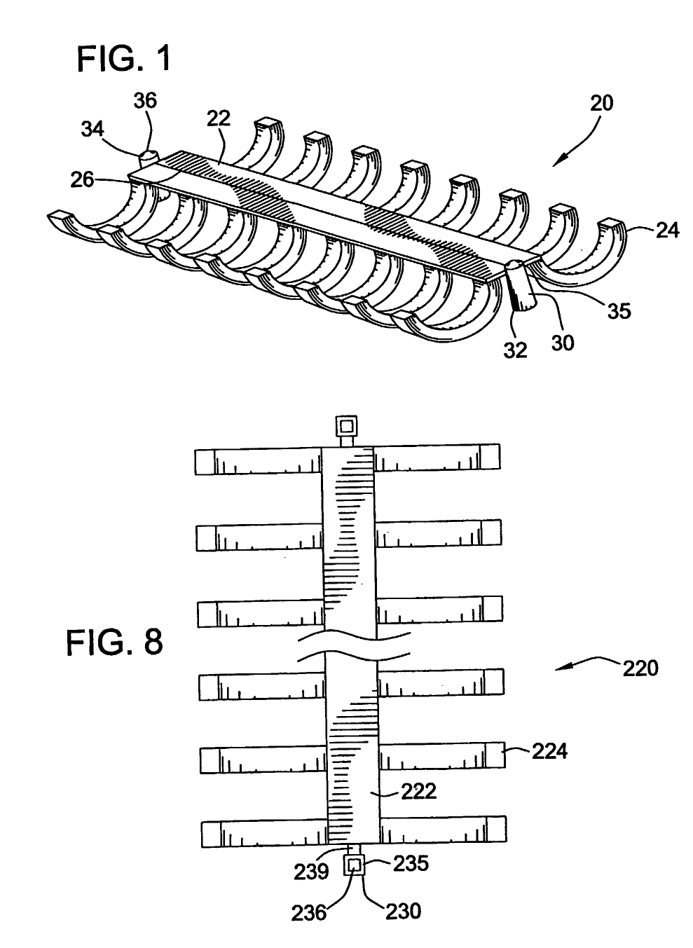

Turning now to the drawings, there is shown in FIG. 1 a binding element 20 which includes a spine 22 and a plurality of fingers 24 which protrude from either side of the spine 22. The spine 22 may further include a living hinge 26 or the like which facilitates the bending of the fingers 24 toward one another. In this way, the fingers 24 may be inserted through perforations in a stack of sheets (not shown) to bind the sheets together. In the embodiment illustrated, the living hinge 26 is in the form of a longitudinally extending line of reduced thickness along the spine.

In accordance with the invention, the binder 20 is provided with stacking protrusions or pins 30 by which a plurality of binders 20 may be nested, or stacked, to prevent the binders from becoming tangled. It will further be appreciated by those skilled in the art that the stacking pins 30 facilitate the use of such binding elements in automated processing. A plurality of elements 20 so stacked may be readily handled and fed through automated binding machines (not shown) such that they may be used for high volume binding. The stacking pin 30 may be then be sheared off the element either during the handling process, during the closing process, or after binding.

The stacking pins 30 may be of any appropriate design. The stacking pins 30 shown in FIGS. 1-4 have a generally conical shape with a broad lower end 32 and a narrow upper end 34. The narrow upper end 34 further includes an upper surface 35 from which an upwardly extending nipple 36 protrudes. In order to receive the narrow upper end 34, and the nipple 36, in particular, the stacking pins 30 preferably include an internal cavity 38. As may be seen in FIG. 4, the narrow upper end 34 and nipple 36 are received within the cavity 38 to nest the stacking pins 30 and fix the relative positions of the associated binding elements 20. To further stabilize the nested stacking pins 30, the internal cavity 38 may include a surface or flange 40 which receives the upper surface 35 of the stacking pin. It will be appreciated that the nipple 36 helps to guide the upper end 34 of the stacker into position within the cavity 38. It will be appreciated, however, that the nipple 36, cavity 38 and flange 40 are not required, so long as the pins 30 of adjacent binding elements 20 abut each other to maintain the spatial relationship.

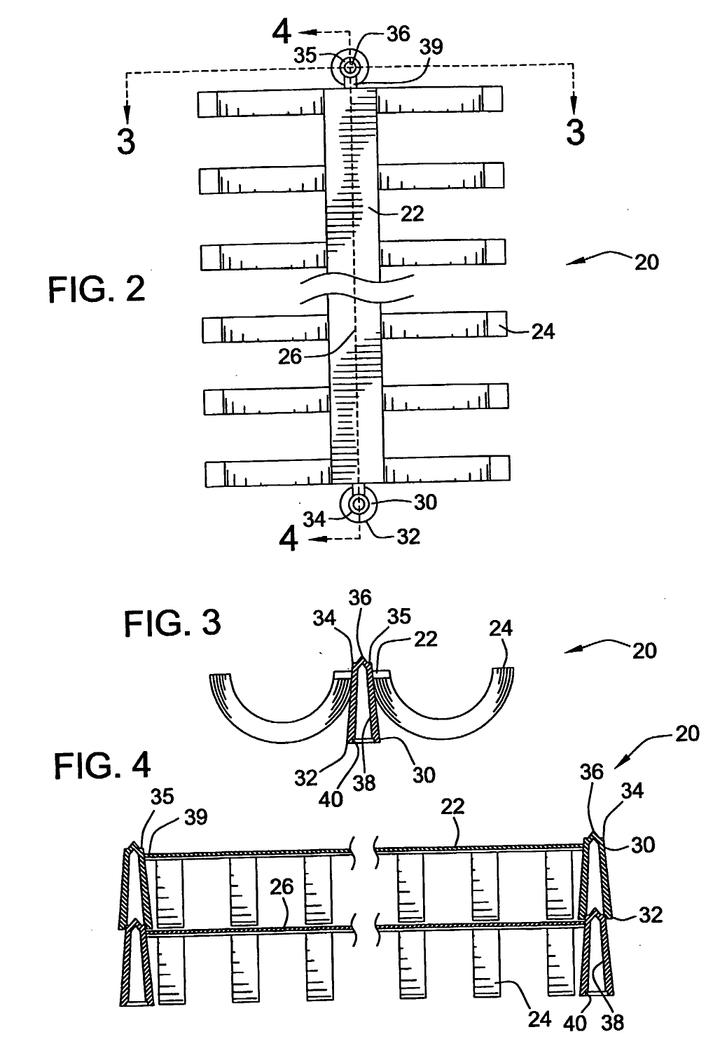

The stacking pins 30 may be coupled directly to the binding element 20, or they may be coupled by means of an arm 39, as shown in FIGS. 2-4. The arm 39 is preferably of a smaller cross-section than the spine 22, for example, so that it may be easily severed from the binding element 20.

It will further be appreciated that the stacking pin may be of an alternate configuration. For example, the stacking pin 30 of FIGS. 1-4 may have a smooth sided simple conical configuration such that the upper surface of the stacking pin and the nipple are one in the same and wherein the point or nipple of the cone is received within an internal cavity.

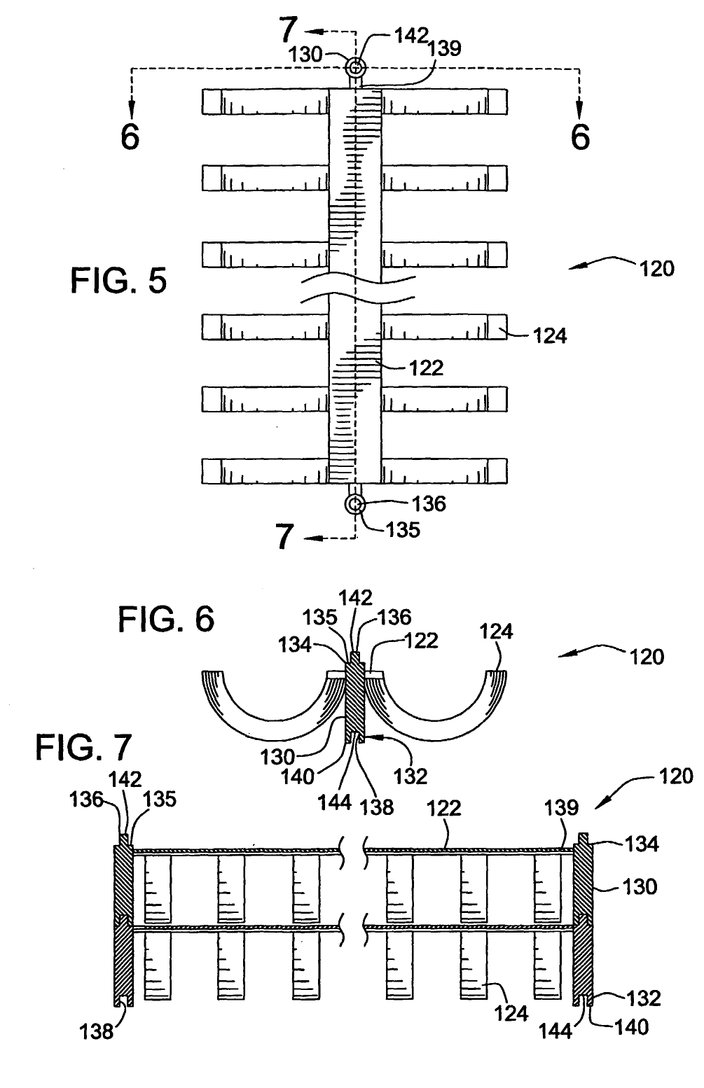

Alternately, the stacking pin 130 may have a configuration such as is shown in FIGS. 5-7, for example. (It will be noted that in this and subsequent embodiments, similar identification numbers are utilized with a different number prefix, i.e., 1xx is used for this embodiment, 2xx for the next, etc.) In this embodiment, stacking pin 130 is an elongated cylinder having a lower end 132 and an upper end 134. The upper end 134 includes a surface 135 from which a nipple 136 extends. When nested, the upper surface 135 of the pin seats against lower surface 140, while the upper surface 142 of the nipple 136 seats against the base surface 144 of the cavity 138. It will be appreciated, however, that the pins 130 would appropriately nest regardless of which surfaces engage, i.e., the pins 130 would likewise appropriately nest if only surface 142 engaged 144 or if only surface 135 engaged surface 140, rather than both.

In this configuration, the stacking pin 130 have a circular configuration. The stacking pin 230 may alternately include a square configuration, such as is illustrated in FIG. 8. It will be appreciated that the cross-sectional side elevation views of the stacking pin 230 will be substantially similar to the cross-sections shown in FIGS. 6 and 7.

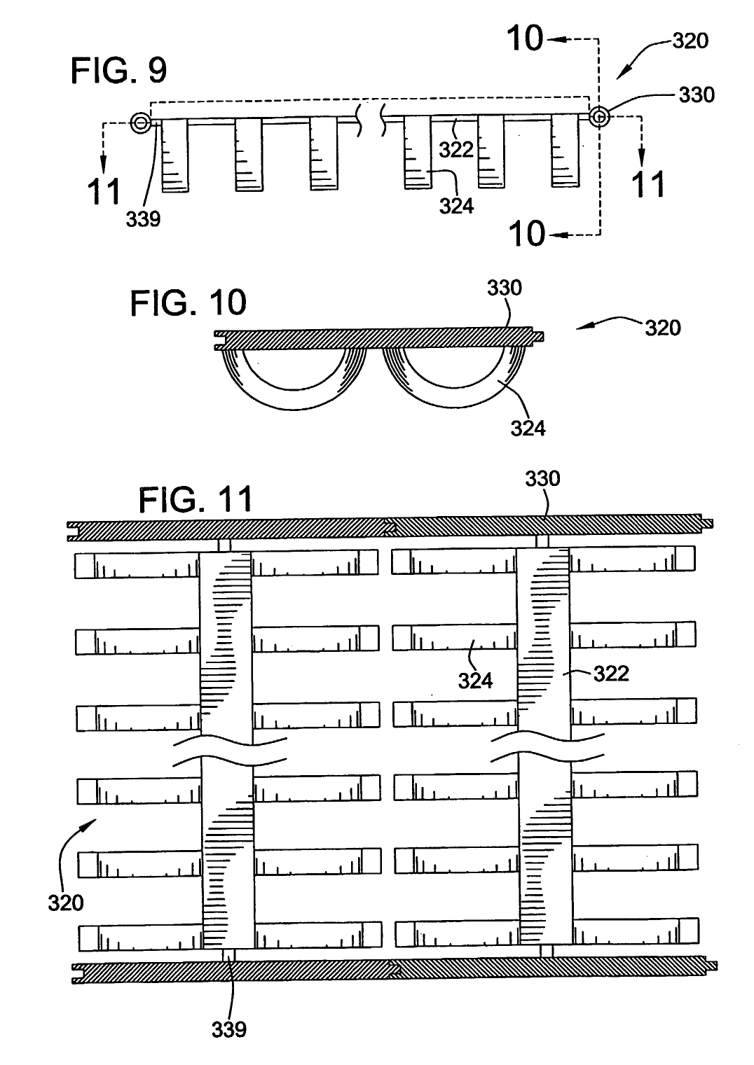

Further, while the stacking pin 30 has been illustrated as extending perpendicular to a plane containing the binder element 20 and as facilitating a vertical stack of binding elements 20, it will be appreciated that the stacking pins 330 may be utilized to stack binding elements 320 in a horizontal configuration, such as is shown in FIGS. 9-11. In this embodiment, the stacking pins 330 extend substantially parallel to or in the same plane as a plane containing the binding element 320. In this way, the binding elements 320 are disposed side-by-side when positioned by the stacking pins 330. The stacking pins 330 are illustrated as having generally the same configuration as is illustrated in the embodiment shown in FIGS. 5-7, however, the stacking pin 330 is slightly more elongated, running substantially the width of the binding elements 20, as illustrated in FIG. 11. The stacking pin 330 themselves, however, nest in an identical manner to that disclosed and explained with regard to FIGS. 5-7.

While the stackers have been illustrated with regard to a particular binding element 20 design, it will be appreciated by those of skill in the art that the stacking pins may likewise be utilized with other sheet binding element structures, such as those illustrated in, for example, U.S. Pat. No. 4,369,013 to Abildgaard et al., U.S. Pat. No. 4,607,970 to Heusenkveld, U.S. Pat. No. 4,873,858 to Jones, U.S. Pat. No. 4,900,211 to Vercillo, U.S. Pat. No. 4,904,103 to Im, and U.S. Pat. No. 5,028,159 to Amrich et al., each of which is incorporated by reference herein. It will be noted that in Abildgaard et al., the binding elements include fingers in the form of nails and mating female strips having openings for receiving the nails. The nipple and cavity arrangement is not required as long as the stacking pins of adjacent binding elements abut one another to maintain the desired spatial relationship. Further, while the stacking pins preferably protrude from the opposite ends of an elongated spine 22, it will be appreciated that the stacking pins may be alternately positioned along the binder, for example, along the fingers, so long as they do not interfere with the automated processes and so long as they may be severed to provide a final polished product. Additionally, a binding element may include less or greater than two stacking pins and may be formed of a polymeric material or a metallic material, provided these same requirements are met.

I claim:

1. A plurality of binding elements for binding stacks of perforated sheets, each binding element comprising:
an elongated spine,
a plurality of fingers adapted to form a closed loop and spaced to be received in perforations of said sheets, and
at least one stacking pin disposed and sized such that the stacking pin of a first said binding element abuts a stacking pin of a second binding element to substantially maintain said binding elements in a given spatial relationship.

2. The plurality of binding elements of claim 1 further comprising an arm and wherein said stacking pin is coupled to the spine by said arm.

3. The plurality of binding elements of claims 1 or 2 wherein the elongated spine comprises proximal and distal ends, and each binding element comprises two stacking pins, said pins being coupled to the spine at the proximal and distal ends.

4. The plurality of binding elements of claim 1 wherein said at least one stacking pin further comprises a cavity and a nipple, said cavity and said nipple being sized such that the nipple of the first said binding element may be nested in the cavity of the second said binding element to couple the binding elements together and substantially maintain said binding elements in a given spatial relationship.

5. The plurality of binding elements of claim 4 further comprising an arm and wherein said stacking pin is coupled to the spine by said arm.

6. The plurality of binding elements of claim 4 wherein the elongated spine comprises proximal and distal ends, and each binding element comprises two stacking pins, said pins being coupled to the spine at the proximal and distal ends.

7. The plurality of binding elements of claim 4 wherein the pin has a cone shape.

8. The plurality of binding elements of claim 4 wherein the pin has a tip end and a base end, the nipple extending from the tip end and a flange extending outward from the nipple at the tip end, the cavity extending inward from the base end and the base end including a base engagement surface, the flange engaging the engagement surface when the cavity of the second binding element receives the nipple of the first binding element.

9. The plurality of binding elements of claim 8 wherein the pin is substantially cylindrical.

10. The plurality of binding elements of claim 9 wherein the nipple and the cavity are substantially circular.

11. The plurality of binding elements of claim 4 wherein the nipple and the cavity are substantially rectangular.

12. The plurality of binding elements of claims 1 or 4 wherein said pin extends substantially perpendicularly to a plane including the binding element.

13. The plurality of binding elements of claims 1 or 4 wherein the pin extends substantially vertically such that the binding elements are adapted to nest one on top of the other.

14. The plurality of binding elements of claims 1 or 4 wherein the pin extends substantially horizontally such that the binding elements are adapted to be disposed side-by-side.

15. The plurality of binding elements of claim 1 wherein a binding element is unitarily molded of a polymeric material.

16. The plurality of binding elements of claim 1 wherein the stacking pin may be severed from the binding element to provide a binding element having a finished appearance.

17. A plurality of book binding elements for binding stacks of perforated sheets, each binding element comprising,
an elongated spine,
a plurality of nails for engaging perforations in said sheets or a plurality of openings for receiving such nails, and
at least one stacking pin disposed and sized such that the stacking pin of a first said binding element abuts a stacking pin of a second binding element to substantially maintain said binding elements in a given spatial relationship.

18. A method of assembling a binding element into a stack of perforated sheets comprising the steps of:
loading a stack of binding elements having abutting stacking pins coupling the individual binding elements into a binding machine,
engaging a binding element with the stack of sheets,
binding the stack of sheets with the binding element,
severing the stacking pin from the binding element, and
releasing the bound stack from the binding machine.

19. The method of claim 18 wherein the binding and the severing steps are performed substantially simultaneously.

20. The method of claim 18 wherein the severing step is performed before the binding step.

21. The method of claim 18 wherein the severing step is performed after the binding step.

22. The method of claim 18 wherein the severing step is performed before the engaging step.

23. The method of claim 18 wherein the severing step is performed after the releasing step.

24. The method of claim 18 wherein the stacking pins are nested.
